(19) United States
(12) Patent Application Publication
(10) Pub. No.: US 2025/0219190 A1
(43) Pub. Date: Jul. 3, 2025

(54) ENERGY STORAGE DEVICE

(71) Applicant: Daixiu CHEN, Shenzhen, Guangdong (CN)

(72) Inventor: Daixiu CHEN, Shenzhen, Guangdong (CN)

(21) Appl. No.: 18/836,871

(22) PCT Filed: Sep. 20, 2022
(86) PCT No.: PCT/CN2022/120020

§ 371 Date: Mar. 21, 2025

(30) Foreign Application Priority Data
Sep. 20, 2021 (CN) 202111102592.4

(51) Int. Cl. H01M 10/6554; H01M 10/613; H01M 10/647; H01M 10/6551; H01M 50/209

(52) U.S. Cl. CPC H01M 10/6554; H01M 10/613; H01M 10/647; H01M 10/6551; H01M 50/209

(57) ABSTRACT

A battery energy storage device includes a battery module. The battery cell is sheet-like, and the two surfaces of the battery cell along the thickness direction are the main heat dissipation surface of the battery cell. The box body comprises a bottom plate and a plurality of cooling plates arranged on the bottom plate; a holding space is formed between two adjacent cooling plates to accommodate the battery cell. The battery cell is installed in the accommodating space, and the main cooling surface on both sides of the battery cell is respectively fitted with two adjacent cooling plates.

### TECHNICAL FIELD

The invention belongs to the field of energy storage, in particular to an electrochemical energy storage device.

### BACKGROUND TECHNIQUE

New energy lithium battery, compared with traditional dry batteries, fuel cells, with good safety, high energy storage density, easy to carry and other excellent characteristics, in modern mobile phones, computers and other electronic products have been widely used, the current use of lithium battery monomer is mainly composed of the shell and placed in the shell electrolyte solution and battery cell. A positive electrode and a negative electrode are arranged at the top of a lithium battery cell. There is currently technology to place the battery module in the coolant, so that the heat transfer efficiency has a certain increase.

### CONTENT OF INVENTION

The invention provides a soft-pack battery comprising at least one battery cell, the battery cell is externally wrapped with a first packaging layer (such as a metal-plastic composite film, such as an aluminum-plastic film), the first packaging layer comprises a first metal layer (such as an aluminum layer), the battery cell has a top edge and a side edge, the first packaging layer has a cut edge on a top edge and/or a side edge, and the first packaging layer has a cut edge on a top edge and/or a side edge. The first metal layer is exposed in the cut edge.

In a preferred embodiment, the first packaging layer comprises an upper and lower two layers, and a sealing edge is formed between the cut edges of the first packaging layer of the upper and lower two layers.

In a preferred embodiment, a second packaging layer is also wrapped outside the first packaging layer, and the second packaging layer comprises a second metal layer; Alternatively, a second metal layer or metal foil tape is also wrapped around the first packaging layer.

Preferably, the second metal layer is electrically insulated or electrically insulated between the second metal layer and the first metal layer exposed in the cut edge, such that the second metal layer is electrically insulated from the first metal layer.

Preferably, the second metal layer is in direct contact with the coolant when a soft-pack battery wrapped with a second metal layer is immersed in the coolant. The first packaging layer, or the metal-plastic composite film is not in contact with the coolant.

The invention also provides a battery, the battery is a metal hard shell battery, the metal hard shell of the battery is wrapped with an insulating layer, the insulation layer is also wrapped with a second metal layer, the second metal layer and the metal hard shell insulation. Preferably, the insulation strength is greater than 2002V.

In the above content of this application, the “second” is a general reference; For example, the second metal layer generally refers to another metal packaging layer that is different from the metal layer in the metal composite film and wrapped in the external metal packaging layer of the battery cell. The second metal layer can not only prevent penetration, but also avoid electromagnetic radiation, soaking heat and sealing.

The second packaging layer or the second metal layer in the invention are collectively referred to as secondary packaging. Preferably, the creepage distance between the second metal layer and the first metal layer in the cut edge is greater than 2 mm, preferably greater than 4 mm.

Preferably, the coating of the first packaging layer and the coating of the second packaging layer are carried out independently. In other words, the first packaging layer and the second packaging layer are separated before coating, rather than having been combined into a composite packaging film.

Among them, the wrapping process in the cell wrapped with a metal-plastic composite film and the wrapping process further wrapped with a second metal layer are preferably carried out separately. Alternatively, the metal-plastic composite film and the second metal layer are separated before the wrapping cell process, rather than a composite packaging film that has been combined into one body.

The invention also provides a manufacturing method for manufacturing a soft-pack battery, comprising the following steps:

The battery cell is wrapped with a first packaging layer (such as metal plastic composite film, such as aluminum-plastic film), the first packaging layer in the side of the battery cell, top or bottom of at least one of the positions to form a stacked edge, the stacked edge is cut to form a cut edge, the layer between the cut edge is sealed, wherein the first packaging layer contains a first metal layer (such as aluminum layer), The first metal layer is exposed from the first packing layer at the cut edge.

Preferably, two first packaging layers cover the cell from both sides, and the layered first packaging layer is cut at the top edge, bottom edge, and side edge of the cell to form the cut edge.

Preferably, a first packing layer wraps the cell to form a stack on the top edge, bottom edge and a side edge of the cell, and the first packing layer of the stack is cut on the top edge, bottom edge and side edge of the cell to form the cut edge.

Preferably, the first packaging layer is bag-like with openings on one or both sides, the cell is placed in the bag-like first packaging layer, the first packaging layer is stacked at two openings, and the stacked first packaging layer is cut to form the cut edge.

Preferably, a heat seal is formed between the top edge of the cell and a laminated cut edge of the side edge to form a heat seal top edge and a heat seal side edge, the heat seal side edge has a cut edge, and the cut edge exposes the first metal layer from the first packaging layer.

Preferably, an electrical insulation treatment (such as wrapping insulation tape) is applied to the outside of the cut edge of the heat sealing top edge and/or heat sealing side edge, which will expose the first metal layer of the cover.

Preferably, a soft-pack battery is formed by wrapping a second metal layer (such as an aluminum or steel layer) or a metal foil tape (such as an aluminum foil tape, copper foil tape, or stainless steel foil tape) around the first packaging layer (such as a metal-plastic composite film). The soft-pack battery may have a plurality of cells stacked or connected in any direction.

The above steps are preferably carried out in sequence, and there can be other process steps between the steps.

The first packaging layer and the second packaging layer of the invention are both used as packaging materials and can belong to a part of the battery.

Further, the electrical insulation strength (or voltage resistance strength) between the first metal layer and the second metal layer in the cut edge is greater than 1000 volts, preferably greater than 1800 volts. The electrical insulation strength of the invention is X volts, which means that X volts of voltage is applied between the second metal layer and the first metal layer in the cut edge, and there will be no short circuit, creepage or breakdown.

There is no insulator gap between the exposure of the second metal layer and the exposure of the first metal layer, and the linear distance L1 between the exposure of the second metal layer and the nearest exposure of the first metal layer is ≥2 mm; If there is an insulator gap between the exposure of the second metal layer and the exposure of the first metal layer, and the insulator has at least one convex peak, the distance d1 from the highest peak of the nearest insulator ridge from the exposure of the second metal layer, the distance between the highest peak of the adjacent convex peaks, and the distance d2 from the exposure of the first metal layer to the highest peak of the nearest insulator ridge sum L2≥2 mm.

Preferably, L1 and L2 are preferably ≥5 mm independently, and preferably ≥10 mm.

Preferably, L1 and L2 independently preferably ≤50 mm, and preferably ≤40 mm.

Preferably, the second packaging layer covers the cut edge, or the second packaging layer does not cover the cut edge and there is a distance between the edge of the second packaging layer and the cut edge, the distance is ≥2 mm, preferably ≥5 mm, preferably ≥10 mm.

Among them, the first metal layer material is preferably aluminum foil or stainless steel foil or copper foil. The metal-plastic composite film is preferably formed by the combination of the first resin layer, the first metal layer and the second resin layer in sequence, that is, the metal-plastic composite film is formed by the combination of the above three layers. Metal-plastic composite film is preferably aluminum-plastic composite film (referred to as aluminum-plastic film). The second metal layer is preferably aluminum layer.

The first resin layer and the first metal layer and the second resin layer and the second metal layer are successively stacked, and the connection between the two adjacent layers can be directly compounded, or compounded by adhesive or other means.

The cut edge on the heat sealing side edge of the soft-pack cell is preferably sealed by an insulating film to avoid electrical connection or creepage between the first metal layer in the cut edge and the second metal layer, or the cut edge is preferably folded to avoid electrical connection or creepage between the second metal layer.

Further, the second metal layer wraps the cut edge and an insulating film outside the cut edge. The second metal layer is electrically insulated from the first metal layer in the cut edge.

Preferably, the second metal layer is wrapped outside the cut edge and insulation film, and the second metal layer extends outside the side edge of the soft-covered battery, and the two layers of the second metal layer outside the side edge of the soft-covered battery are connected to each other (the connection mode is preferably bonded) to form a seal. Alternatively, the metal-plastic composite film covering the soft-pack battery and the second metal layer are bonded by an adhesive.

Preferably, the inside of the second metal layer is backed with glue in order to make the second metal layer fit well with the metal-plastic composite film.

For the soft-pack battery mentioned above, the cut edge of the metal-plastic composite film is insulated to prevent the exposure of the first metal layer. The insulation treatment method is preferably wrapped with an insulating film seal; Alternatively, the insulation treatment method is preferably to heat seal the side edge of the soft-pack battery to prevent the exposure of the first metal layer.

For the soft-pack battery mentioned above, the adhesive resin is pre-coated on the second metal layer, or pre-coated on the outer surface of the second plastic layer. For example, aluminum foil tape is used as a second metal layer wrapped around the aluminum-plastic film.

The soft-pack battery, as described above, is mutually bonded and sealed by two layers of the second metal layer, which are located on the front and back side edges of the soft-pack battery and extend beyond the side edge of the soft-pack battery.

The invention also provides a soft-pack battery cooling device, which comprises a soft-pack battery and a coolant; The soft-pack battery is wrapped by a soft-pack material (flexible packaging material), and the soft-pack material wrapping the soft-pack battery directly contacts the coolant for heat exchange. The flexible packaging material comprises (or sequentially laminated) a first resin layer, a first metal layer and a second resin layer, and the flexible packaging material also comprises a second metal layer, the second metal layer wrapped in the second resin layer outside. The second metal layer is in direct contact with the coolant.

The first metal layer and the second metal layer are electrically insulated and the insulation strength is greater than 1800 volts. Electrical insulation between the first metal layer and the second metal layer is preferably carried out through an insulating film or hem.

The flexible packaging material of the invention is easy to deform compared with the hard shell outside the square hard shell battery. The flexible packaging material of the invention can be an aluminum-plastic film or a metal foil such as aluminum foil. The primary soft-pack battery can be formed by wrapping the cell with an aluminum plastic film first, and then wrapping the primary soft-pack battery with a second metal layer to form the soft-pack battery of the invention.

A soft-pack battery cooling device comprises a soft-pack battery and a coolant, the soft-pack battery cell is wrapped with a metal plastic composite film, the metal plastic composite film contains a first metal layer, the soft-pack battery has a heat sealing top edge and a heat sealing side edge, the heat sealing side edge has a cut edge, the cut edge has a first metal layer; The metal plastic composite film is also wrapped with a second metal layer, and the cut edge and the second metal layer are electrically insulated or treated with electrical insulation, and the second metal layer is in direct contact with the coolant.

A soft-pack battery cooling device comprises a coolant and one of the soft-pack batteries, and a second metal layer outside the soft-pack battery is in direct contact with the coolant for heat exchange.

The cut edge of the metal-plastic composite film refers to the cut edge of the hot sealing edge of the soft-pack battery (that is, the cut edge of the hot sealing edge or the hot sealing side). The cut edge usually contains a resin layer (such as a PP layer) and a first metal layer. The cut edge is the cross section of the hot sealing edge after the heat sealing of two layers of metal plastic composite film.

In order to express more clearly and conveniently, the invention is described as follows: the thermal sealing edge of the soft-pack battery is divided into a top thermal sealing edge (referred to as a top edge) and a side thermal sealing edge (referred to as a side edge), and sometimes there is a thermal sealing edge, the soft-pack battery has a body and a thermal sealing edge, and the four or three peripheral edges of the body of the soft-pack battery have a thermal sealing edge.

The technical solution of the invention can solve the long-term insulation problem of the power battery in the cooling water in the prior art, and ensure that the insulation strength and leakage current between the cooling night and the positive and negative electrodes of the cell meet the requirements of the prior art standard (such as the insulation strength greater than 1800 volts and the insulation resistance greater than 100 ohms/volts). Solve the insulation problem during the long-term operation of the vehicle (such as more than 10 years).

The thickness of the aluminum foil in the aluminum foil tape is preferably 40 microns to 200 microns.

The scope of documentation of the technical scheme in the invention also includes various feasible combinations of the scheme or technical features. The invention will not be repeated here.

A battery module comprises a plurality of the cells and a coolant, and the battery module is structured to have the following structure and function: at least part of the outermost layer of the packaging material on the cell body is in direct contact with the coolant for heat exchange, and the cut edge of the cell seal edge is not in contact with the coolant.

The invention discloses a sealing structure for the coolant in the battery module, such that at least part of the outermost layer of the packaging material on the battery body is in direct contact with the coolant for heat exchange, and the cut edge of the battery seal edge is not in contact with the coolant.

The battery coolant sealing structure comprises a plurality of the cell and the coolant, and the sealing interface is arranged between at least part of the cell body and the cut edge of the cell sealing edge, so that at least part of the outermost layer of the packaging material on the cell body directly contacts the coolant for heat exchange, and the cut edge of the cell sealing edge does not contact the coolant.

The invention also provides: as described above, the cut edge is optionally replaced by the cut edge of the second metal layer (if any).

The battery cell can be selected as a hard shell battery cell or a soft-pack battery cell.

The first metal layer in the cut edge of the cell seal edge is not in contact with the conductive coolant and is not electrically connected.

A battery module comprises a plurality of soft-pack batteries and a coolant, the soft-pack battery is packaged by an aluminum-plastic film, and a second metal layer (preferably a second aluminum foil layer) is packaged outside the aluminum-plastic film, the battery module is constructed with a sealed structure such that at least part of the second aluminum foil layer is in direct contact with the coolant and all cut edges on the aluminum-plastic film are not in contact with the coolant.

A battery module comprises a plurality of batteries and a coolant. The battery has a metal shell, an insulating layer is wrapped outside the metal shell, and a second metal layer is packaged outside the insulation layer. The battery module is constructed with a sealed structure such that at least part of the second metal layer is in direct contact with the coolant while the insulation layer is not in contact with the coolant.

Wherein the coolant in the above series of schemes contains at least 5% or at least 6% mass fraction of water.

Any of the battery modules or sealing structures mentioned above, further, the battery modules or the sealing structure also comprises a sealing frame, the sealing frame comprises one or two top edges of the frame; The battery comprises a top edge. The top edge of the battery is stacked between the top edge of the battery and the top edge of the adjacent sealing frame, and the top edge of the frame and the top edge of the battery form a sealing interface. In some embodiments, the sealing frame preferably includes a type Il or structure.

Further, the battery is preferably a square hard-shell battery or a soft-pack battery. Among them, for the square hard shell battery, there are usually 6 surfaces, where the positive and negative electrode is the top surface, and the top surface without electrode (if any) is the bottom surface, the surface around the top surface is the side edge, the top edge of the battery is the sealing edge corresponding to the top edge of the frame, the top edge of the battery may be on any edge closer to the positive and negative electrodes of the battery relative to the side edge of the battery, This edge is used to set the seal. The top edge of the battery can be arranged on the top surface of the battery or on a side surface near the top surface.

The battery may be a single cell, or a cell group consisting of two or more cells.

The sealing frame is preferably any frame structure containing a sealing structure; The sealing frame can be either an independent component or an integrated component integrated with other structures. In other words, the sealing frame can be either an independent component or integrated on other components.

Further, the sealed frame also comprises one or two frame side edges. The battery also includes a side edge. The side edge of the battery is stacked with the side edge of the frame of the adjacent sealing frame. The side edge of the frame forms a sealed interface with the side edge of the battery.

Among them, for the square hard-shell battery, the battery typically features two large side surfaces and two small side surfaces. The side edge of the battery is the edge on either side of the top edge of the battery, which can be used to set the seal. The battery side edge is usually on both sides of the large side surface of the square hard-shell battery, and can also be on both sides of the small side surface.

A sealing frame of a soft-pack battery comprises a frame on both sides of a cut edge of a battery; and a sealing surface is formed between the frame and the battery sealing edge.

Preferably, the sealing frame includes a type Il or structure, and the sealing frame includes one or two top frame edges and, preferably, one or two side frame edges. The Il or u type is the basic or approximate shape.

A battery system with a sealed frame (preferably a soft-pack battery), the frame forms a sealing surface with the battery to isolate the cut edge on the battery from the coolant.

Preferably, the sealing frame includes a border located on either side of the cut edge of the battery, forming a sealing surface between the border and the battery.

Preferably, the sealed frame comprises one or two frame top edges and one or two frame side edges. The top edge of the frame, the side edge of the frame and the sealing edge of the battery form a sealing surface.

Preferably, the sealing surface may be between the cut edge and the cell, or preferably, the sealing surface may also be at the position of the cell. Preferably, there are at least two batteries in each sealed frame, and the sealing surface is formed between the two batteries. The sealing surface may be located between the cut edge and the cell, or, preferably, the sealing surface may be located at the position of the cell, or the edge of the side of the battery away from the cut edge.

Preferably, the second metal layer of the battery is near the cut edge end, in the area between the sealing surface and the cut edge.

Preferably, when the battery is in use, the side of the sealing surface away from the cut edge is the area of contact with the coolant.

After long-term observation, the inventor found that if the traditional battery cell is directly placed in the cooling water, its heat transfer efficiency is greatly improved, but the cooling water will very slowly penetrate through the side of the battery cell, resulting in gas production and gradual failure. After trying different technologies in different fields, the inventor suddenly finds that the method and structure of the invention can solve the above problems. The sealing frame is mainly used to seal the battery module, prevent the coolant from leaking outside the sealing edge or penetrating into the inside of the battery cell through cut edge, and make the module structure compact. The sealing surface may optionally be formed on the sealing edge of the battery or on the body of the battery; The sealing edge of the battery can be either a thermal sealing edge of the soft-pack battery or an edge of the second metal layer on the battery. Further, the sealing frame can also support and tighten the battery.

Among them, the top edge of the frame is sealed and fitted with the top edge of the battery for sealing the top edge of the battery. The side edge of the frame is sealed and fitted with the side edge of the battery to seal the side edge of the battery.

The present invention provides a cell submodule comprising a stack of two or more cells stacked together and a second packaging layer wrapped around the stack. The second packaging layer may be an anti-corrosion layer that prevents the coolant from corroding and penetrating into contact with the battery. Among them, the so-called “layering” can be a layering in any direction, or a combination of layering in multiple directions, and can form a battery group after wrapping the second packaging layer outside the layering. The packaging of the battery stack can be any surface of the battery side surface and the bottom surface, such as the large side surface and the bottom surface of the battery or battery group, or the small side surface and the bottom surface of the battery or battery group, or the large side surface and the small side surface of the battery or battery group. The top edge of the battery stack is the edge closer to the tab of the stack than the side edge.

Preferably, the cell submodule also includes an elastic material (preferably an elastic foam) sandwiched between two batteries, which buffers the volume change of the battery as it expands.

The anti-corrosion layer can be directly wrapped in the outer side of the laminate body, or indirectly wrapped in the outer side of the laminate body (the so-called indirect packaging means that there are other layers between the anti-corrosion layer and the laminate body).

The anti-corrosion layer preferably comprises a metal layer.

As an embodiment, the anti-corrosion layer is preferably an aluminum foil layer or an aluminum-plastic composite film.

The invention is different from the prior art in that the anticorrosive layer, which blocks water penetration and corrosion, is placed after the finished cell and then wrapped, and the problem of insufficient insulation strength and electrical gap between the anticorrosive layer and the cut edge of the aluminum-plastic film is creatively solved.

The invention also provides a sealed frame for a battery having one or two frame top edges and having one or two frame side edges connected to the frame top edge and frame side edge; The top edge of the frame can be sealed and fitted with the top edge of the battery cell, and the side edge of the frame can be sealed and fitted with the side edge of the battery cell or can be sealed and fitted with the side edge of another frame. Preferably, a through-hole for coolant flow is also provided on the side edge of the frame.

The invention also provides a battery module comprising a plurality of sealed frames, a plurality of battery units, and a coolant. The frame has one or two top edges of the frame and one or two side edges of the frame, and the top edge of the frame is connected with the side edge of the frame; The top edge of the sealing frame is sealed and fitted with the top edge of the battery unit, the side edge of the frame is sealed and fitted with the side edge of the battery unit or the side edge of another frame, and at least part of the battery unit body is in direct contact with the coolant, and if there is a cut edge on all the edges of the battery (including the top edge and the side edge), the cut edge is not in contact with the coolant.

The battery unit of the invention can be a single cell, a laminated body or a combination of multiple cells, and can also be the cell submodule.

Preferably, the battery is a metal hard shell battery, the metal hard shell of the battery is wrapped with an insulating layer, and the insulation layer is also wrapped with a second metal layer between the second metal layer and the metal hard shell. Further, the insulation strength is greater than 2001V. Further, when a battery wrapped with a second metal layer is immersed in a coolant, the second metal layer is in direct contact with the coolant.

The invention also provides a battery module comprising a plurality of sealing frames, a plurality of battery cells, and a coolant, the frame having one or two frame top edges, and may further have one or two frame side edges, the frame top edge is connected with the frame side edge, the seal frame top edge is sealed and fitted with the battery unit. Further, the side edge of the frame is sealed and fitted with the battery unit or the side edge of another frame, and at least part of the body of the battery unit is in direct contact with the coolant. Wherein, the coolant preferably contains at least 6% mass percentage of water.

The invention also provides a battery module comprising a plurality of sealed frames, a plurality of battery cells, and a coolant. The frame has one or two frame top edges, and has one or two frame side edges, and the frame top edge is connected with the frame side edge. The top edge of the sealing frame is sealed and fitted with the top edge of the battery unit. Further, the side edge of the frame is sealed and fitted to the side edge of the battery unit or to the side edge of another frame, and at least part of the body of the battery unit is in direct contact with the coolant. Further, if there is a cut edge on all sealed edges of the battery (including the top edge and the side edge), the cut edge is preferably not in contact with the coolant. Wherein, the coolant preferably contains at least 5% water.

As an alternative, through holes for coolant flow are also provided on the side edge of the frame.

As the battery module mentioned above, the further battery unit is preferably one of the above secondary wrapped batteries.

The above battery module, further, the frame formed in the cavity is also integrated with the coolant baffle, the baffle around the frame is connected as one. The baffle can not only organize the flow field of the coolant but also strengthen the stiffness of the sealing frame.

The battery unit of the invention is preferably a soft-pack battery or a soft-pack cell submodule or a square hard-shell battery or a square hard-shell cell submodule. Wherein, when the battery unit is a square hard shell battery or battery unit, the top edge of the battery for sealing refers to the part on the battery corresponding to the top edge of the sealing frame, and the side edge of the battery for sealing refers to the part on the battery corresponding to the side edge of the sealing frame. The edge on the battery for sealing (such as the sealing top edge and the sealing side edge) can be the edge of the square hard-shell battery, and the top edge of the battery is preferably the edge on the battery near the positive and negative electrodes. The edge of the battery cell can also be formed by the secondary wrapping material. The secondary wrapping material wraps the body of the battery and extends beyond the body of the battery, and two layers of the secondary wrapping material are mutually bonded to form the edge of the battery. The sealing edge of the battery cell formed by the hard shell battery can be without cut edge. The battery may be a square hard-shell battery with six surfaces, and the positive/negative electrodes may be either on the same surface or on two opposite surfaces. The battery can also be a soft-pack battery, which has two large surfaces and 3 or 4 hot sealing edges, and the positive/negative electrodes can be either on the same side or on the opposite two sealing edges. In the invention, the frame side edge (or sealed side edge) and the frame top edge (or sealed top edge) can be on the same single battery, or can be respectively on different single batteries. The frame side edge (if any) can cover either the entire battery side edge or only part of the battery side edge.

When there is a secondary packaging material outside the battery or cell submodule, the sealing frame and battery unit sealing and fitting refers to the sealing frame and the secondary packaging material outside the battery unit sealing and fitting.

The invention provides a battery module comprising the cell submodule and a separator which are successively stacked, and between the cell submodule and the separator a fluid channel for coolant flow is formed. The separator may optionally be a separator having a runner passage, that is, a runner plate.

As one of the preferred solutions, a sealing structure or a sealing structure is arranged between one or two or at least three of the four perimeters of the partition board and the batteries on both sides of the partition board, and the coolant flows in the sealing structure. The partition board may optionally be a runner plate with a sealed frame around it. The sealing frame is preferably a sealing rubber strip.

Preferably, the sealing surface between the frame and the first or second packaging layer is sealed by a sealant.

Preferably, the sealing surface between the frame and the first packaging layer or the second packaging layer is sealed by an elastomer that is pressed at the sealing surface position between the frame and the first packaging layer.

Preferably, the cut edge surrounds the edge of the cell, and the frame is annular around the cell, and the frame is provided with a through-hole for the coolant to pass through.

The invention provides another soft-pack battery module, the module comprises a plurality of soft-pack batteries and a plurality of sealing frames, the sealing frame comprises a plurality of frame edges, the soft-pack battery comprises a plurality of sealing edges (referred to as sealing edges); The sealing edge of the soft-pack battery is sandwiched in the frame edge of the two adjacent sealing frames, and the sealing edge of the frame edge and the sealing edge of the soft-pack battery form a sealing interface. The module also contains a coolant when the soft-pack battery is charged and discharged or when the module is assembled on the vehicle; The soft-pack battery body is in direct contact with the coolant for heat transfer (or the outermost wrapping material wrapping the soft-pack battery body is in direct contact with the coolant for heat transfer, or the outermost wrapping material wrapping the soft-pack battery body is in direct contact with the coolant for heat transfer). The frame edge forms a sealing interface with the sealing edge of the soft-pack battery, which can make the coolant seal directly contact with the body of the soft-pack battery to avoid the coolant from the sealing edge to spill or flow; Thus, the coolant is avoided from contacting the cut edge of the battery seal, and the coolant is also avoided from contacting the positive and negative electrodes of the battery.

In the present invention, two adjacent sealing frames are either optionally made close to each other, or optionally made adjacent to each other by the inclusion of other parts in the middle. The frame edge may be a top edge of the frame, a side edge of the frame, or a bottom edge of the frame (if any).

In the present invention, a sealed frame refers to a structure in which the frame edge (top edge of the frame and/or side edge of the frame) forms a sealed interface with the battery sealing edge; Two adjacent sealing frames can either be closely adjacent to each other or contain other parts between them.

The sealing edge of the soft-pack battery may be a sealing top edge, a sealing side edge, or a sealing bottom edge (if any). The sealing edge can be sealed by heat seal or adhesive seal. These sealing edges have an open cut edge, and there is a sealant in the opening cut edge (the sealant can be a heat sealing resin or adhesive). If these cut edges are exposed to the coolant (that is, the cut edge is in direct contact with the coolant), it is easy to cause the coolant to slowly penetrate from the sealant in the cut edge, so the sealing interface is formed through the frame edge and the soft-pack battery sealing edge. So that all cut edges are spatially isolated from the coolant. Power pack batteries typically feature 4 side edges, which are divided into sealed edges and flanged edges. There is no cut edge on the folding edge, while there is a cut edge on the sealing edge. The soft-pack battery can have 4 sealing edges, or it can have 3 sealing edges and 1 folding edge.

Preferably, the sealing interface can withstand a coolant hydraulic pressure with a relative pressure of more than 2 bar (preferably more than 5 bar) such that the coolant touching the battery body does not leak through the sealing interface from this side edge of the battery body to the other side edge of the sealing interface.

The invention also provides a battery module comprising a plurality of batteries and a plurality of sealed frames; The sealing frame comprises a top edge of the frame and a side edge of the frame located on one side or both sides of the top edge of the frame, and the top edge of the frame forms a sealing interface with the top edge of the battery, and the capacity of the battery is greater than 10 amp hours.

Further, the side edge of the frame forms a sealed interface with the side edge of the battery.

A coolant is also contained in the module when the battery is charged and discharged or when the module is assembled on the vehicle; The battery body is in direct contact with the coolant for heat transfer, or the outermost wrapping material of the battery body is in direct contact with the coolant for heat transfer.

The invention also provides another battery module, which comprises a plurality of batteries and a plurality of sealed frames; The sealing frame comprises a top edge of the frame and a side edge of the frame located on one or both sides of the top edge of the frame, and a sealing interface is formed between the top edge of the sealing frame and the battery.

Further, a sealing interface is formed between the side edge of the sealing frame and the battery. The battery is preferably a hard-shell battery or a soft-pack battery. Further, the module also contains a coolant when the battery is charged and discharged or when the module is assembled on the vehicle; The battery body is in direct contact with the coolant for heat transfer (or the outermost wrapping material wrapping the battery body is in direct contact with the coolant for heat transfer, or the outermost wrapping material wrapping the battery body is in direct contact with the coolant for heat transfer). The sealing frame in the invention may refer to a general term for a component having a sealing function and comprising a top edge frame structure, or a top edge and side frame structure. The sealing frame can be either a flat plate shape, or a broken line frame shape or a broken line segment shape. The sealing frame may consist only of a top edge and/or a side edge, or may be a component integrated by a top edge, a side edge and a partition board. The top edge or side edge may also be an edge with a sealing function.

The invention also provides a battery module comprising a plurality of batteries arranged in a stack and a coolant channel between the batteries, the battery is wrapped with an insulating layer, the insulation layer is wrapped with an anti-corrosion layer or a protective layer, and the anti-corrosion layer between the adjacent batteries or one or two or at least three periphery of the protective layer is arranged with a sealing structure. The sealing structure allows the coolant to flow through the coolant channel between adjacent batteries without leaking out of the sealing structure.

One of the problems with the existing technology is that the cells are completely submerged in the coolant, which leads to the large weight and size of the modules. After in-depth research, the inventor boldly adopted a new sealing structure, which can make the module as a whole more compact and strong; And its use in combination with the protective layer can make the module can use water, an efficient and inexpensive medium, which breaks through the traditional immersion cooling to avoid the imprisonment of water.

The anti-corrosion layer is preferably a metal layer or a metal-plastic composite film. The sealing structure can be coated with a sealant on a perimeter between batteries, or a sealing strip can be arranged on a perimeter between batteries.

The invention also provides another battery module comprising a plurality of cells and a coolant, and the battery module is structured so that at least part of the body of the cell is in contact with the coolant and the cut edge of the sealing edge of the cell is not in contact with the coolant.

The battery module comprises a plurality of soft-pack cells and a coolant, the soft-pack cell is packaged by an aluminum-plastic film, the soft-pack cell's aluminum-plastic film contains a first metal layer, the soft-pack cell's aluminum-plastic film is also wrapped with a protective layer, the coolant can conduct electricity, which is constructed into (a structure with the following functions): At least part of the protective layer for wrapping the soft-pack cell is in direct contact with the conductive coolant for heat exchange; The insulating strength between the first metal layer in the aluminum-plastic film of the soft-pack battery and the conductive coolant is greater than 2002 volts. The protective layer is used to isolate the aluminum-plastic film and the coolant of the soft-pack battery.

Further, the protective layer comprises a second metal layer, and the electrical insulation strength between the first metal layer and the second metal layer is greater than 2002 volts.

Further, there is no insulator gap between the exposure of the second metal layer and the exposure of the first metal layer, and the linear distance L1 between the exposure of the second metal layer and the nearest exposure of the first metal layer is ≥2 mm; If there is an insulator gap between the exposure of the second metal layer and the exposure of the first metal layer, and the insulator has at least one convex peak, the distance d1 from the highest peak of the nearest insulator ridge from the exposure of the second metal layer, the distance between the highest peak of the adjacent convex peaks, and the distance d2 from the exposure of the first metal layer to the highest peak of the nearest insulator ridge sum L2≥2 mm.

The invention also provides a battery module, which comprises a plurality of soft-pack batteries and a coolant. The soft-pack battery is packaged by an aluminum-plastic film; A first metal layer is included in the aluminum-plastic film of the soft-pack battery, and a protective layer is also wrapped in the aluminum-plastic film of the soft-pack battery, and the coolant can conduct electricity, which is constructed into (a structure with the following functions): At least part of the protective layer for wrapping the soft-pack battery is in direct contact with the conductive coolant for heat exchange, and the insulation strength between the first metal layer in the aluminum-plastic film of the soft-pack battery and the conductive coolant is greater than 2002 volts;

The battery module is also constructed to have the following sealing structure: the sealing interface is arranged between at least part of the body of the soft-pack battery and the cut edge of the sealing edge of the soft-pack battery so that at least part of the protective layer on the body of the soft-pack battery is in direct contact with the coolant for heat exchange, while the cut edge of the sealing edge of the soft-pack battery is not in contact with the coolant.

A soft-pack battery module comprises a plurality of soft-pack cells and a coolant, the soft-pack cell is packaged by an aluminum-plastic film, the aluminum-plastic film contains a first aluminum foil layer, the soft-pack cell is also wrapped with a second plastic insulation layer outside the aluminum-plastic film, the second plastic insulation layer is also covered with a second aluminum foil protection layer outside the second plastic insulation layer; The soft-pack battery module is structured to have the following functions: at least part of the second aluminum foil protective layer is in direct contact with the coolant for heat exchange, and the electrical insulation strength between the first aluminum foil layer and the second aluminum foil protective layer in the aluminum-plastic film is greater than 2000 volts; Or/and, the electrical gap between the first aluminum foil layer and the second aluminum foil protective layer is greater than 2.2 mm.

The invention also provides another battery module, which comprises a plurality of batteries and a plurality of sealed frames; The module also contains a coolant; The cut edge on the sealing side of the battery is sealed between the frame sides of the two adjacent sealing frames, so that the cut edge on the sealing side edge is isolated from the coolant; The body of the battery is in direct contact with the coolant for heat transfer. This avoids direct contact between the cut edge and the coolant.

The invention also provides a rectangular aluminum hard shell battery module scheme, which comprises a plurality of rectangular aluminum hard shell batteries and a conductive coolant. The rectangular aluminum hard shell is wrapped with a plastic insulating layer, and the plastic insulating layer is also wrapped with an aluminum foil protective layer; The electrical gap between the rectangular aluminum shell and the aluminum foil protective layer is greater than 2 mm; and,

The battery module also includes a sealing structure for sealing the coolant, and the sealing surface of the sealing structure is arranged between at least part of the aluminum foil protective layer outside the rectangular aluminum hard shell battery and an edge of the aluminum foil protective layer, so that the coolant is in direct contact with at least part of the aluminum foil protective layer and not the plastic insulating layer. The sealing surface is preferably arranged along the edge on the aluminum foil protective layer. The sealing surface is preferably arranged by applying sealant.

The rectangular aluminum hard shell battery may contain one or more square aluminum shell cells. The length of the rectangular aluminum hard shell battery can be selected from 100 mm to 2500 mm, preferably from 600 mm to 2500 mm.

The invention also provides another battery (preferably a square hard-shell battery or a soft-pack battery) module, which comprises a plurality of batteries or battery groups and a plurality of sealed frames; The sealing frame comprises a top edge of the frame and a side edge of the frame located on one or both sides of the top edge of the frame, and the top edge of the frame forms a sealing interface with the top edge of the battery or battery group. This prevents the coolant from contacting the tab and/or the cut edge of the top edge through the top edge. The battery is preferably a battery with a capacity greater than 10 amps. The battery is preferably a lithium battery containing nickel. The frame side edge can form a sealing interface with the adjacent frame side edge, and can also form a sealing interface with other parts.

In the battery module as described above, further, the frame side edge forms a sealed interface with the side edge of the cell or battery group.

Among them, the battery group contains two or more batteries, and the two or more batteries are wrapped with waterproof film or waterproof foil (waterproof foil is preferably aluminum foil). When the battery group is wrapped with waterproof foil, “frame and battery group form a sealing interface” means “frame and the waterproof foil outside the battery group form a sealing interface”. The sealing frame may be formed by a sealing rubber strip or a part containing a sealing rubber strip. The battery group is also preferably sandwiched with a fireproof layer or/and a foam layer. The cells in the battery group may be stacked in any direction.

The battery group is preferably a square hard shell battery group or a soft-pack battery group. The top edge of the battery group is the edge near the pole lug (tab).

For example, two batteries are sandwiched with a foam layer to form an intermediate, which is wrapped with a layer of aluminum foil as an anti-corrosion layer. When a coolant passes through the battery module, the anti-corrosion layer is in contact with the coolant, and the plastic layer on the battery is not in contact with the coolant.

For example, the top edge of the soft-pack battery group is formed by pressing the top edge of the two or more soft-pack batteries together and wrapping a second aluminum foil layer, and the side edge of the soft-pack battery group is formed by pressing the side edges of the two or more soft-pack batteries together and wrapping a second aluminum foil layer.

The invention also provides another square metal hard shell battery module, which comprises a plurality of metal hard shell batteries arranged in a stack, and the metal hard shell battery is wrapped with an insulating layer; The insulation layer is wrapped with a waterproof layer (the waterproof layer is preferably an aluminum foil layer or preferably contains an aluminum foil layer), and the module also comprises a coolant channel arranged between two adjacent metal hard shell batteries. Preferably, the insulation strength between the metal hard shell and the waterproof layer is greater than 1000V and further greater than 2002V.

Preferably, the creepage distance between the metal hard shell and the aluminum foil layer is greater than 2 mm and further greater than 4 mm.

Preferably, the metal hard shell battery is a blade battery.

The battery module or sealing structure as described above also contains a plurality of sealing frames, the sealing frame has a frame top edge and two frame side edges, the frame side edge is located on both sides of the frame top edge. Further, the sealing frame also has a frame bottom edge which is located on the side of the frame opposite to the top edge of the frame.

Or further, the sealing frame has two frame top edges and a frame side edge, the frame side edge is located on the same side of the frame top edge.

Or further, the sealing frame has two frame top edges and two frame side edges, and the frame side edges are located on both sides of the frame top edge.

Alternatively, the sealing frame has two frame top edges arranged roughly parallel to each other.

Preferably, the sealing frame comprises a type Il or u structure, and the sealing frame comprises one or two top edges of the frame and two or one side edges of the frame. Π type (referred to as “Π” font) or □ type (referred to as “□” font) for the approximate shape (or basically Π or □ type), it can be an integrated molding, can also be a combination of molding. Among them, the top edge of the frame is fitted with the top edge of the battery to seal the top edge of the battery. The frame side edge is fitted to the battery side edge to seal the battery side edge.

In the battery module or sealing structure as described above, the top edge of the frame forms a sealed interface with the top edge of the battery, which can seal the coolant that is in direct contact with the battery body to prevent the coolant from spilling out from the top edge.

In the battery module or seal structure described above, the side edge of the frame forms a sealed interface with the side edge of the battery, which seals the coolant to avoid the coolant spilling out from the side edge, and/or seals the coolant to avoid the coolant coming into contact with the cut edge of the battery, if any.

If the battery is a soft-pack battery, the cut edge of the battery preferably refers to the cut edge of the hot sealing edge or sealing edge of the soft-pack battery. If the battery is a hard-shell battery, the cut edge of the battery refers to the cut edge of the second packaging layer or waterproof layer outside the hard-shell battery.

“So that the coolant is sealed” can also be understood as “so that the coolant cannot flow through the sealing interface”; Or “such that the coolant does not penetrate through the sealing boundary to the other side”. The soft-pack battery body refers to the part of the soft-pack battery that bulges up and wraps a positive and negative jelly roll, and the battery cell wrapped inside generates heat during work and needs to be cooled. At least part of the battery body of the invention is immersed in the coolant to exchange heat with the coolant.

The direct contact between the battery and the coolant refers to the direct contact between the outer packaging material wrapped in the battery and the coolant. The outer packaging materials for the battery include the packaging materials for directly wrapping the battery cell, and the packaging materials for secondary packaging (or indirect packaging). When the battery has a secondary packaging material, the “battery body and coolant direct contact” refers to the packaging material on the battery body for secondary wrapping and the coolant direct contact. The so-called secondary packaging material refers to the packaging material that the material is wrapped in the outside of the battery that has an outer packaging material (primary packaging material). A battery with a secondary package, which is in direct contact with the coolant, means that the secondary package material is in direct contact with the coolant. The so-called secondary package is only a general term, but also includes more than two packages and other multiple packages.

The technical problems to be solved by the invention are different, and the technical schemes adopted and the technical effects obtained are also different. Another feature of the invention is that the secondary wrapping layer outside the battery does not need to completely wrap all the outer surfaces on the battery body; Preferably, only the outer surface of the cell in the sealed frame can be wrapped twice, which can bring about the technical effect of simplifying the wrapping process.

According to the layout of the positive and negative electrodes, the battery can be divided into two types: Type A and type B. The so-called Type A battery means that the positive and negative electrodes are drawn from the same side.

The so-called B-type battery means that the positive and negative electrodes are drawn from opposite sides. For the soft-pack battery, the heat seal edge with the pole lug protruding is defined as the top edge, so the type A cell has only 1 top edge; Type B cells have two top edges (first and second). For square (can also be called rectangular) hard shell batteries, the sealing edge near the positive and negative terminals is defined as the top edge, and the sealing edge on both sides of the top edge (if any) is defined as the side edge. The pole lug in the invention refers to the positive and negative electrodes of the battery. The sealing edge where the pole lug of the soft-pack battery is located is the top edge. The surface where the pole lug of the square hard shell battery is located is the top surface, and the pole lug can also be called the pole column. The top edge of the square hard shell battery for sealing can be arranged either on the top surface or on the side surface. The side of the square hard-shell battery for sealing is usually arranged on both sides of the top edge, which can be arranged on the same side or on two opposite sides.

The soft-pack battery may have one top heat seal edge (type A soft-pack battery), that is, both the positive and negative lugs (tabs) extend outward from the top heat seal edge; The soft-pack battery may also have two or more top thermal sealing edges (type B soft-pack battery), that is, the positive and negative lugs extend outward from the opposite two thermal sealing edges. The square hard-shell battery typically features 6 surfaces, the A-type square hard-shell battery typically features 1 top surface, 1 bottom surface and 4 side surfaces, and the B-type square battery typically features 2 top surfaces and 4 side surfaces.

For A type A soft-pack battery, the side edge opposite the top edge is the bottom edge, and the bottom edge can be a hot sealing edge or a folding edge (the folding edge does not require heat sealing, and there is no cut edge).

For a type B soft-pack battery, if the type B soft-pack battery has only one heat-seal side edge, the bottom edge refers to the side edge without a heat-seal edge and a cut edge. If a type B battery has two heat-sealed side edges, the type B battery has no bottom edge.

The soft-pack battery can be 3 heat sealing edges (or sealed edges), and 1 folded edge, which does not need heat sealing but can be folded in half; There can also be no folded edge, that is, the 4 edges are heat-sealed or sealed edges.

The cut edge (also referred to as the cut surface) of the invention, for the soft-pack cell, preferably refers to the cross section of the outermost edge of the heat sealing edge, usually the middle part of the cross section is the polypropylene layer; For a square hard-shell battery, it refers to the transverse section of the most edge of the secondary packaging layer (if any). When the battery is a soft-pack battery, the edge of the secondary packaging layer preferably does not belong to the cut edge described in the invention. In the absence of an explicit qualification, the cut edge of the present invention preferably refers to the cut edge on the first packaging layer.

As the battery module, further, the side edge or bottom edge of the sealing frame is provided with an empty cavity, or the side edge or bottom edge of the adjacent two sealing frames is formed between the empty cavity, the cavity is used for the inflow or outflow of coolant. Alternatively, an empty cavity is arranged on the side edge or bottom edge of the sealing frame on the adjacent side edges of the partition board, or an empty cavity is formed between the side edge or bottom edge of the sealing frame on the adjacent sides of the partition board for the inflow or outflow of the coolant.

The other is a battery module as described above, where the sealing frame does not have a bottom edge (for example, the sealing frame is of type n structure), and the coolant flows in or out from the separator between the bottom of the adjacent battery.

Such as the battery module, further, the module also includes a bottom plate, which forms a seal with the bottom of the sealing frame (such as the open side of the Il type sealing frame), and the bottom or bottom plate of the battery module has an inlet and outlet for the coolant.

The battery module as described above, and further, the battery, with the exception of the outermost wrapping material in contact with the coolant, the rest of the parts (including: the cut edge of the battery, the resin layer or adhesive layer in the middle of the flexible packaging material, the sealing adhesive layer or resin layer for bonding the outermost wrapping material) are not in contact with the coolant. Among them, the outermost wrapping material can also be the outermost wrapping material.

The top edge of the sealing frame refers to the edge on the sealing frame fitted with the top edge of the battery, and the side edge of the sealing frame refers to the edge on the sealing frame fitted with the side edge of the battery. Of course, the sealing frame may also have a frame bottom edge, which corresponds to the bottom edge of the battery.

Further, the weight of a single sealing frame is preferably 1.6 g to 9992 g.

Further, the thickness of a single sealing frame is preferably 0.4 to 93 mm; Preferably 0.5˜92 mm.

Further, the battery of the invention is a soft-pack battery or a hard-shell battery. Further, the soft-pack battery is preferably lithium-ion soft-pack battery; The hard-shell battery is preferably lithium-ion hard-shell battery.

Further, the material of the sealing frame of the invention is preferably a sealing frame containing a plastic.

The battery in the above scheme has a positive metal foil and a negative metal foil, and the thickness of the positive metal foil is preferably 3.2 to 48 microns. The thickness of the negative metal foil in the battery is preferably 3.3˜47 microns; It is preferred to be 3.4˜46 microns. The positive metal foil and the negative metal foil serve as the fluid collector for the battery jelly roll.

The invention also provides a method for manufacturing a battery module, including:
A sealing frame is provided which comprises a sealing edge (the sealing edge includes a sealing top edge and/or a sealing side edge);
A battery is provided and the sealing edge of the battery is laminated to the sealing edge of the sealing frame;
Another sealing frame is provided and the sealing edge of the other sealing frame is laminated to the sealing edge of the battery;
Repeat the stacking process of the battery and the sealing frame until the required number of battery modules is obtained;
Among them, a sealant is coated between the sealing edge of the battery and the sealing edge of the sealing frame, so that a sealing surface is formed between the sealing edge of the sealing frame and the sealing edge of the battery.

The invention also provides a method for manufacturing a battery module, including:
A sealing frame and a plurality of batteries are provided, wherein the sealing frame has a sealing edge and the battery has a sealing edge;
The sealing frame and the battery are successively laminated so that the sealing edge of the sealing frame forms a seal with the sealing edge of the battery;
For square hard-shell batteries, the edge of the battery can be the edge of the second packaging layer.

In the above method, the sealing method is preferably to coat the sealing edge of the sealing frame and the sealing edge of the battery with sealant or provide a sealing pad to seal the coolant, so that the coolant flowing on the surface of the battery body is not in contact with the cut edge.

The module of the invention refers to a certain combination of a plurality of single cells, and is a module in a broad sense, which can be a standard module, a large module that is not a VDA standard, or a whole battery pack. As one of the preferred options, if the entire battery pack contains only one large module, the entire battery pack is considered a large module.

The coolant of the invention can be various liquid media, such as silicone oil, ester coolant, water-based coolant, etc.; Preferably water, or antifreeze coolant (or antifreeze) containing ethylene glycol and at least 11% water by mass fraction, or lubricating oil. Unless otherwise specified in the present invention, all percentage contents are mass fraction percentages or weight fraction percentages.

The thickness of the battery body in the invention can be selected from 2 to 200 mm, preferably from 2.7 to 43 mm.

Preferably, the battery module in Part III of the invention also includes a temperature sensor. The temperature sensor is used to measure the temperature of the battery or coolant in the module.

In the invention, the so-called cut edge non-contact coolant means that at least the cut edge of the core sealing edge which forms a sealing surface with the sealing frame does not contact the coolant; Preferably, all cut edges do not touch the coolant. For soft-pack batteries, the cut edge does not touch the coolant so that the heat-sealing plastic layer in the aluminum-plastic film does not touch the coolant.

The invention also provides the following battery module scheme: if the battery module is one of the battery module schemes, the battery is one of the battery schemes. Specifically, the following scheme is included, only as an example:

A battery module comprises a plurality of batteries arranged in a stack and a plurality of sealed frames; The sealing frame comprises a top edge of the frame and a side edge of the frame on either side of the top edge of the frame, the battery has a top edge and a side edge, the top edge of the battery is arranged between the top edge of the frame of the two sealing frames, the top edge of the frame and the top edge of the battery form a sealing interface; The side of the battery is arranged between the side of the frame of the two sealing frames, and the side edge of the frame and the side edge of the battery form a sealing interface. The module also contains a coolant when the battery is charged and discharged or when the module is assembled on the vehicle; Direct contact heat transfer between the battery body and the coolant (or direct contact heat transfer between the outermost packaging material wrapped around the battery body and the coolant); The battery is wrapped with a first metal layer, and the battery is also wrapped with a second metal layer, and the second metal layer is electrically insulated or electrically insulated between the second metal layer and the first metal layer, so that the second metal layer is electrically insulated between the first metal layer and the second metal layer. When the battery body is immersed in the coolant, the second metal layer is in direct contact with the coolant. Moreover, the sealing frame forms a sealing interface with the second metal layer so that the first metal layer does not contact with the coolant.

A soft-pack battery module comprises a plurality of soft-pack batteries and a plurality of sealed frames which are stacked; The sealing frame comprises a top edge of the frame and a side edge of the frame located on one side edge or both side edges of the top edge of the frame. The top edge of the soft-pack battery is arranged between the top edge of the frame of the two sealing frames, and the top edge of the frame and the top edge of the soft-pack battery form a sealing interface; The side edge of the soft-pack battery is arranged between the side edge of the frame of the two sealing frames, and the side edge of the frame and the side edge of the soft-pack battery form a sealing interface. The module also contains a coolant when the soft-pack battery is charged and discharged or when the module is assembled on the vehicle; The soft-pack battery body is in direct contact with the coolant for heat transfer; Wherein, the battery cell of the soft-pack battery is covered with a metal plastic composite film, the metal plastic composite film contains a first metal layer, the soft-pack battery has a heat sealing edge and a heat sealing side edge, the heat sealing side edge has a cut edge, the cut edge has a first metal layer; The metal-plastic composite film of the soft-pack battery is also wrapped with a second metal layer or a metal foil tape, and the second metal layer is electrically insulated or electrically insulated between the second metal layer and the first metal layer in the cut edge, so that the second metal layer is electrically insulated between the first metal layer and the second metal layer. When the soft-pack battery body is immersed in the coolant or when the soft-pack battery body is heated with the coolant, the second metal layer is in direct contact with the coolant. Moreover, the sealing frame forms a sealing interface with the second metal layer, so that the metal plastic composite film does not contact with the coolant.

The battery module comprises a plurality of cells and a coolant, the cell is packaged by an aluminum-plastic film, the aluminum-plastic film contains a first aluminum foil layer, the aluminum-plastic film also contains a layer of plastic layer layered on the outside of the first aluminum foil layer, the aluminum-plastic film is at least also covered with a second protective layer, the second protective layer comprises a second aluminum foil protection layer; The battery module is constructed to have the following functions:

At least part of the second aluminum foil protective layer is in direct contact with the coolant, and the electrical insulation strength between the first aluminum foil layer in the aluminum-plastic film and the second aluminum foil protective layer is greater than 2002 volts; Or/and, the electrical gap between the first aluminum foil layer and the second aluminum foil protective layer is greater than 2.2 mm; Also,

The battery module also has the following sealing structure, the sealing interface is arranged between at least part of the cell body and the cut edge of the cell sealing edge (or between the edge of the secondary wrapping material), so that at least part of the outermost layer of the packaging material on the cell body is in direct contact with the coolant. The cut edge of the sealing edge of the cell does not contact the coolant or the edge of the secondary wrapping material does not contact the coolant.

At least one insulating layer is sandwiched between the first aluminum foil layer and the second aluminum foil protective layer, and preferably the distance between the edge of the first aluminum foil layer and the edge of the second aluminum foil protective layer is more than 2 mm; Alternatively, the edge of the first aluminum foil layer is sealed by an insulating material such that the electrical gap between the first aluminum foil layer and the second aluminum foil protective layer is infinite.

The second protective layer is arranged with an adhesive layer so that the second protective layer is well bonded and attached to the battery cell. The adhesive is preferably a pressure sensitive adhesive.

Further, a second plastic insulating layer is arranged between the aluminum-plastic film and the second aluminum foil protective layer. The second plastic insulating layer, after the aluminum-plastic film wraps a battery jelly roll) to form a battery cell, wraps the battery cell a second time.

Further, the battery module also comprises a plurality of sealing brackets, the sealing bracket comprises a sealing top edge and a sealing side edge, the sealing top edge between the sealing top edge and the top sealing edge of the battery cell on both sides is formed between the sealing side edge and the side sealing edge of the battery cell on both sides is formed between the sealing surface, So that the coolant is in contact with the outermost packaging material on the body of the battery cell and is not in contact with the cut edge of the sealing edge of the battery cell or the edge of the secondary packaging material of the battery cell.

The second protective layer of the invention is preferably wrapped twice after the battery jelly roll is wrapped by an aluminum-plastic film to form a battery cell. The secondary wrapping mentioned in the invention refers to that the wrapping layer and the previous packaging layer are wrapped separately, rather than together. The aluminum-plastic film is separated from the second plastic insulating layer before the cell is wrapped.

Function: The second aluminum foil protective layer can play the role of water barrier, heat conduction, temperature equalization, and electromagnetic shielding, and can also reduce the cost increase caused by multi-layer composite, as well as disperse the expansion force of the cell. The second aluminum foil protective layer also helps solve the problem of insufficient electrical gap and insulation strength by using a secondary wrapping method.

The invention also provides a method scheme for making a battery module, which comprises the following steps:

The utility model provides a soft-pack battery cell which has been wrapped in aluminum-plastic film, the aluminum-plastic film comprises a first aluminum foil layer;

Provides a second protective layer comprising a second aluminum foil layer, A second protective layer is wrapped around the soft-pack cell, The electrical gap between the second aluminum foil layer and the first aluminum foil layer in the aluminum-plastic film is greater than 2 mm; and

A sealing structure is arranged in the battery module so that at least part of the outermost packaging material on the soft-pack cell body is in contact with the coolant, and the cut edge of the soft-pack cell seal edge is not in contact with the coolant.

The frame top edge and frame side edge of the sealing frame of the invention contain both integrated molding and assembled molding, and also contain a combination of a plurality of parts with corresponding functions; but preferably in one piece. The side edge of the frame can either form a sealing surface with the cell sealing edge, or form a sealing surface between the side edges of the two frames. In some technical schemes of the invention, the orientation indicated by the so-called top edge or side edge is only for the convenience of describing the invention and simplifying the description, rather than indicating the specific orientation it must have, and cannot be understood as a limitation of the invention.

The invention also provides an energy storage device, which comprises one of the battery modules.

Further, the capacity of the battery module in the energy storage device is in the range of 1.7 KWH to 970 KWH. Further, the energy storage device also comprises at least two temperature sensors.

In the absence of contradiction and clarity, the battery in the battery module scheme of the invention can be understood as a relatively independently packaged single battery or a battery group containing multiple single batteries. That is, the battery can be either a single battery or a battery group or cell submodule containing a plurality of single batteries that need to be externally wrapped in a second packaging layer.

The cell and the battery in the invention have the same meaning provided that there is no contradiction in meaning and no special indication or distinction is made. The cell in the technical proposal may be a single cell, or a cell stack or a battery group or cell submodule containing multiple cells. The cell or battery in all schemes of the invention can be selected as a square hard-shell battery or a soft-pack battery.

The invention also provides a number of integrated battery assembly schemes similar to those described in the United States patent application, public number US20210159567A1. However, one of the distinguishing features of the following scheme is that the coolant in the coolant channel in the provided integral battery assembly is in direct contact with the outer surface of the battery cell, and the heat transfer between the coolant and the battery cell does not need to pass through the wall surface of the cooling tube.

An integral battery assembly scheme 1 comprises:
a plurality of battery cell arrays, wherein a single battery cell array comprises a number of battery cells, the battery cell is arranged in a common direction to form a row of battery cells;
a coolant channel formed around the battery cell;
a sealing material formed by a resin compound, wherein the sealing material surrounds the cell array and provides a seal for the cell array to seal the coolant.
a bottom surface used to support the plurality of cell arrays; and
a top surface covered on the plurality of cell arrays.

Further, the coolant channel is a cavity formed between the sealing material surrounding the upper part of the battery array and the sealing material surrounding the lower part of the battery array.

An integral battery assembly scheme 2 comprises:
a plurality of battery cell arrays, wherein a single battery cell array comprises a plurality of battery cells arranged in a common orientation; the top surface of each cell is basically aligned, and the battery array forms a basic horizontal plane along the top surface of the cell;
a coolant channel formed around the battery array;
a potting material formed by a resin compound, the potting material enclosing the cell array and providing structural support for the cell array;
a bottom surface used to support and protecting the plurality of cell arrays; and
a top surface covered on the plurality of cell arrays.

The invention also provides a subordinate scheme of the integral battery assembly scheme 1 and 2. These subordination schemes also have any one or more of the following additional technical characteristics. The cell array may contain one or more cells.

The integral battery assembly, wherein the cell is externally wrapped with an insulating layer, is described above. Further, the insulation layer is surrounded by a second protective layer. Preferably, the second protective layer covers only the outer surface of the cell body in contact with the coolant.

The integral battery assembly as described above, wherein a first sealing material is arranged around the upper part of the cell, and/or a second sealing material is arranged around the lower part of the cell. An empty cavity is formed between the first sealing material and/or the second sealing material and the battery cell, and the cavity is a coolant channel for coolant flow. Wherein, the potting material is preferably arranged only on the upper part of the first sealing material and the lower part of the second sealing material, and there is a coolant channel between the first sealing material and the second sealing material.

The integral battery assembly, wherein the coolant channel is a cavity formed between the sealing material around the upper part of the battery cell and the sealing material around the lower part of the battery cell.

The integral battery assembly as described above, optionally, where the sealing material and the potting material are of the same material.

The integral battery assembly, as described above, is further, in which the coolant in the coolant channel is in direct contact with the outer surface of the cell.

In the integral battery assembly described above, further, the coolant is an insulating oil or an ester substance, or is water containing at least 5% by weight percentage.

The integral battery assembly is described above, wherein the battery cell is a cylindrical or rectangular battery cell.

The integral battery assembly, as described above, may also include one or more side surfaces. The side surface can be sealed with a coolant channel between the battery cell.

The integral battery assembly, as described above, is further sealed with a coolant channel between the top surface and/or bottom surface and the cell.

The integral battery assembly, further, wherein the potting material bonds the cell array, bottom surface and top surface into one to provide structural support. The top surface can be a module lid or a battery pack top surface. The bottom surface can be a module bottom surface or a battery pack bottom plate.

In order to provide a clearer and more complete description, the integral battery assembly provided by the invention may also have other technical characteristics, provided that it is not explicitly defined and applicable. Such other technical features and drawings may be used or referenced by reference to the corresponding technical features and drawings in US20210159567A1. The invention will not be repeated here. The integral battery assembly of the invention is also an energy storage device, or is also regarded as a battery module in a broad sense.

The scope of documentation of the technical scheme in the invention also includes various feasible combinations of the scheme or technical features. Embodiments of the present invention have been provided, and are not repeated in the present invention. The technical features in some technical schemes of the invention support each other functionally and interact with each other, form an inseparable whole, and cannot be disassembled at will.

In the present invention, a subsequent scheme referencing the aforementioned scheme may include references to all feasible sub-schemes of all the aforementioned schemes. For example, scheme 2 refers to scheme 1, including scheme 1 and its feasible sub-schemes.

In the present invention, the technical features after the expression “further” or “further again” or “preferably” can be used as additional technical features of subschemes or subordinate claims.

In the present invention, further additional technical features are applicable to all subordinate technical schemes, provided that there is no contradiction in meaning. A dependent technology solution may contain only one additional technology feature or several additional technology features at the same time.

### ILLUSTRATED DESCRIPTION

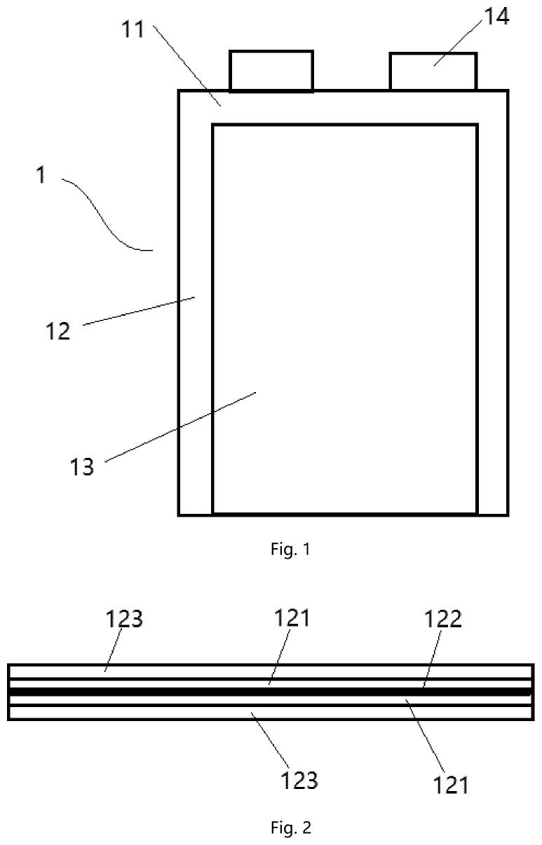

FIG. 1 shows A diagram of a Type A battery, the type A battery has a body 13 and 1 top heat sealing edge 11 and 2 side heat sealing edge 12, and a cut edge 120 is provided on the heat sealing side edge 12; The battery is a soft-pack battery.

FIG. 2 Schematic diagram of the cross section (that is, cut edge) 120 on the outermost edge of the thermal sealing edge of the soft-pack battery, which is sequentially stacked into protective layer (such as nylon) 123, aluminum layer 121, thermal sealing layer (such as PP) 122, aluminum layer 121, protective layer 123, wherein PP layer is relatively easy to let water gas through and enter the cell.

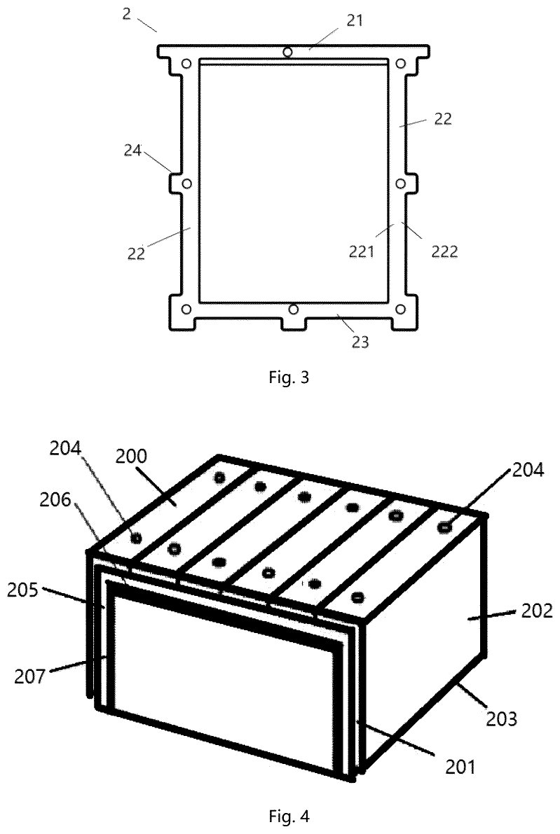

FIG. 3 type structure sealing frame, including 1 frame top edge 21, 2 frame side edges 22, 1 frame bottom edge 23.

FIG. 4 Embodiments of a laminated body and a battery group of the invention.

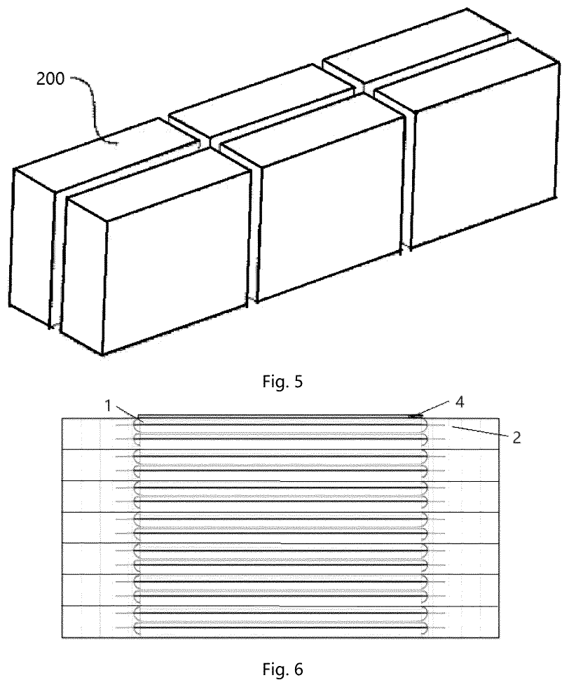

FIG. 5 Another embodiment of a laminated body of the invention.

FIG. 6 Battery module inner core, which comprises 14 cells and 21 sealing frames and 8 partitions.

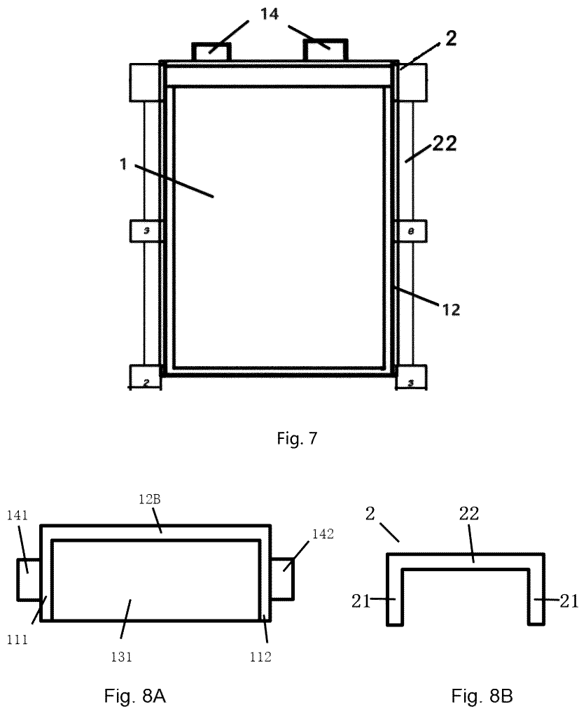

FIG. 7 The battery 1 is assembled in the sealing frame 2, and the pole lug (tab) 14 protrudes from the top edge of the frame, wherein the cut edge of the hot sealing edge of the battery is placed in the middle of the sealing frame side edge 22, and the inside and outside sides of the sealing frame side are immersed in cooling water, but the cut edge of the battery is isolated from the cooling water in space.

FIG. 8A shows a type B battery, which comprises a first pole lug 141 and a second pole lug 142. The two pole lugs are located on opposite sides of the battery body 131, and FIG. 8B shows a structural diagram of a sealing frame used for the battery.

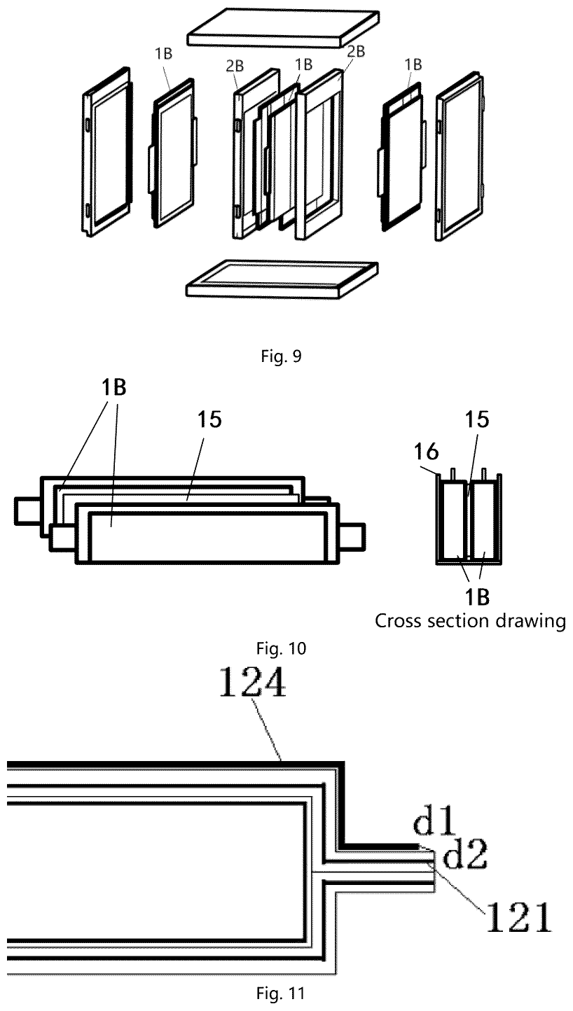

FIG. 9 Another battery module comprising a battery 1B and a sealing frame 2B.

FIG. 10 is a schematic diagram of a cell submodule of the invention.

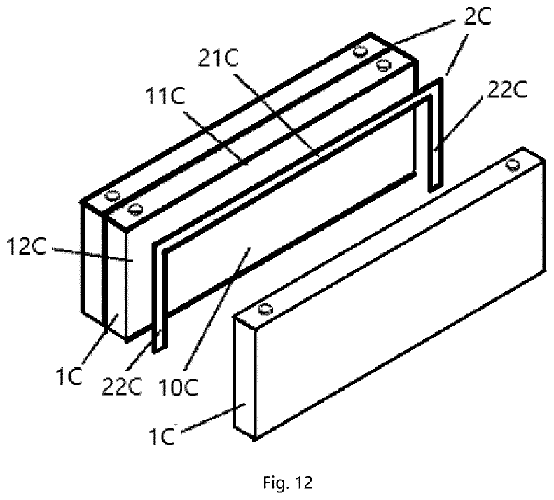

FIG. 11 shows the measurement method of the distance between the first metal layer and the second metal layer.

FIG. 12 shows a part of another battery module, which contains three hard shell cells 1C and two sealing frames 2C, the sealing frame is of type n structure.

### SPECIFIC EMBODIMENTS

### Embodiment 1

In this embodiment, the battery is in direct contact with the coolant for heat transfer. The top of the battery is provided with a pole lug 14, the battery contains at least one battery cell, the battery can be selected as a soft-pack battery. The cell is wrapped by a flexible packaging material comprising a first resin layer (PP resin layer), a first metal layer (aluminum alloy layer) and a second resin layer (nylon layer and/or PET layer).

For example, as shown in FIG. 1, the cell 1 May be a flat rectangular structure comprising a body 13 with a sealed top edge 11 and a sealed side edge 12 around the body 13. The flexible packaging material has a cut edge 120 on a top and/or side edge, and the first metal layer is exposed at the cut edge 120.

The flexible packaging material comprises two layers wrapped above and below the battery cell. The two layers of flexible packaging material are sealed between the cut edges, forming a sealing side edge 12 at the side edge and a sealing top edge 11 at the top. Pole lug (tab) 14 protrudes from seal top edge 11.

As shown in FIG. 2, the traditional battery sealing edge and cut edge of the layer of flexible packaging materials, from the top to the bottom of the protective layer (second resin layer, such as nylon) 123, aluminum layer 121, heat sealing layer 122, aluminum layer 121, protective layer 123, the first resin layer after heating heat sealed together. The battery often uses PP layer as the heat sealing layer, and the PP layer is easy to let water gas through and enter the cell.

The cut edge of the flexible packaging material is insulated to wrap the exposed first metal layer. The insulation treatment method adopts insulation film sealing package; Or the first metal layer of the battery heat seal is hemmed to prevent exposure.

Furthermore, in the present embodiment, a second metal layer (for example, an aluminum alloy layer) may also be wrapped outside the second resin layer, but the second metal layer is not required in the present embodiment. The second metal layer and the second resin layer are bonded by a bonding resin, and the bonding resin is coated on the second metal layer in advance. When there is a second metal layer, as shown in FIG. 11, there is only one sharp Angle between the top of the second metal layer 124 and the first metal layer 121. The distance between the top of the second metal layer 124 and the sharp Angle is d1+ The distance between the sharp Angle and the first metal layer (which can also be regarded as the thickness of the second resin layer at the cut edge) d2≥2 mm. Alternatively, the first packaging layer of the lower layer is turned over at the cut edge of the first packaging layer of the upper layer, covering the cut edge of the first packaging layer, and the cut edge of the first packaging layer of the lower layer is towards the second metal layer 124. The cut edge of the first metal layer 121 in the first packaging layer of the lower layer is not less than 2 mm away from the second metal layer 124.

Referring to FIGS. 3 and 7, the sealing frame 2 comprises a top edge 21 and a side edge 22 located on either side of the top edge. The top edge of the frame 21 forms a sealed interface with the sealed top edge 11 of the battery 1 to seal the coolant to avoid coolant overflow. The inner side edge 22 of the sealing frame 2 forms a sealing interface with the sealing side edge 12 of the battery 1, and the outer side of the two adjacent frame sides forms a sealing interface to seal and isolate the coolant to avoid contact between the coolant and the cut edge of the battery. The coolant is an antifreeze consisting of ethylene glycol and at least 11% water. Referring to FIG. 6, eight fins 4 are also provided between the batteries and outside the modules, which are used to separate the batteries and form a coolant flow path between the batteries. There are 2 batteries between each of the two fins, so as to ensure that each battery has at least one large surface in direct contact with the coolant for heat transfer.

The cut edge (cross section) of the hot sealing edge of the battery contains polymer polypropylene PP layer 122, which has not very good long-term water gas barrier. If the PP layer is placed in the cooling water and the cooling water is in direct contact, the water in the cooling water will penetrate through the PP layer and react with the electrolyte to produce hydrofluoric acid. Therefore, it is necessary to avoid direct contact between cooling water and the cut edge of the battery, so as to extend the battery life.

There is also a sealant between the two adjacent sealing frames in this embodiment, in which the cut edge of the battery is sealed. Alternatively, the sealing frame consists of a sealing frame skeleton (such as plastic or metal parts) and an elastic seal (such as rubber parts) integrated together. The seal frame skeleton of the two adjacent seal frames clamps the elastic seal and the heat seal edge on the side edge of the battery so that the cut edge of the battery is sealed between the elastic seal.

For example, the sealed frame 2 consists of two sections that hold the battery in the middle. Among them, the side edges of the two parts clamp the side heat sealing edge of the battery, and the side edge of the battery side cut edge near the battery body is coated with sealant. The sealant binds the side edges of the two parts to the side heat sealing edge of the battery to form a sealing surface. Alternatively, the cut edge of the side edge of the battery side near the battery body is provided with an elastomer. The elastomer can be set on the side edge of one or both parts, or it can be set on the aluminum-plastic film, or the second resin layer of the aluminum-plastic film itself is elastic or replaced by an elastomer. The elastomer is sandwiched between the side edge of the two parts and the side heat sealing edge, and forms a sealing surface through the elastic force.

FIG. 3 shows that the sealing frame is a type structure, including the top edge 21, the bottom edge 23 and the left and right side edge 22 of the frame. If the battery contains a bottom hot sealing edge (i.e. a hot bottom sealing edge), the cut edge of the hot bottom sealing edge is sealed between the bottom edge 23 of the two adjacent sealing frames.

With reference to FIG. 3, a cavity 221 is arranged on the side edge of the sealing frame, or a cavity 221 is formed between the side edges of the adjacent sealing frame. The cavity is used for the inflow or outflow of the coolant so that the coolant flows through one side of the cavity and contacts the battery body for heat exchange, and then flows out through the other side of the cavity.

In this embodiment, the sealing surface adopts sealing method B, that is, EPDM rubber sealing strip is affixed to all the hot sealing edges of the battery cell near the body 13. The side edge, top edge and bottom edge of the sealing frame are sealed between the EPDM rubber sealing strip and the heat sealing edge to form a sealing surface. On the side that does not contain a heat seal edge, the sealing frame can be without a side, so that the coolant can enter the area restricted by the sealing frame through the side without a heat seal edge. The cut edge of the sealing edge is isolated outside the coolant by the sealing surface.

The cost is medium, about 8 yuan.

The connecting surface shall be sealed (2.5 bar for pressure preservation and leakage: 20 Pa@60 s).

Medium process convenience (assembly time about 22 minutes); Water vapor permeability 0.006 g/24 h, water vapor permeability is small.

In the present embodiment, the sealing surface adopts a sealing method C: that is, a sealant is coated on all the hot sealing edges of the cell near the body 13. The side edge, top edge and bottom edge of the sealing frame are sealed between the sealant and the heat sealing edge to form a sealing surface. On the side that does not contain a heat seal edge, the sealing frame can be without a side edge, so that the coolant can enter the area restricted by the sealing frame through the side without a heat seal edge. The cut edge of the sealing edge is isolated outside the coolant by the sealing surface.

The cost is low, about 3.1 yuan.

Good reliability, completely sealed (2.5 bar pressure holding, maximum leakage is only 5 Pa@60s) (all 10 samples are well sealed).

The process is convenient (assembly time is about 10 minutes) and easy to automate (time can be further reduced).

Water vapor permeability <0.001 g/24 h, almost no water vapor penetration.

For Contrast Example 1, the sealing frame in Embodiment 1 is not used, and sealing mode A is adopted: that is, the battery is only sealed at the top edge. In this case, the sides are exposed to water;

The cost is higher, about 12 yuan. The reliability is poor, the edges and corners are easy to leak slightly (2.5 bar pressure holding, leakage amount up to 120 Pa@60s), and the leakage probability is very high (all 10 samples have leakage of different degrees);

Poor process convenience (assembly time is about 1 hour);

Water vapor permeability 0.018 g/24 h, water vapor permeability is large, side seepage, water vapor permeability is large.

It can be found that in the above sealing methods B and C, when all the hot sealing edges of the cell are sealed, the water vapor permeability is greatly reduced, and the sealant is low cost and good sealing.

### Embodiment 2

This embodiment is roughly the same as that of Embodiment 1, except that the battery is a type B battery and the positive and negative lugs come out from opposite sides respectively. In FIG. 8A, positive lug 141 and negative lug 142 are located at opposite ends of the battery body 131. The Type B battery has two top edges, namely the first top edge 111 and the second top edge 112. Accordingly, the sealing frame comprises a first frame top edge and a second frame top edge, as well as one or two frame sides. Either frame side extends from the top edge of the first frame to the same side of the top edge of the second frame. FIG. 8B shows the sealing frame of type Il structure for type B battery, including 1 frame side 22 and 2 frame top 21. The two top edges 21 are placed at the first top edge 111 and the second top edge 112. Sealed in the manner of Embodiment 1, side 22 is placed at side 12B of the battery. Sealed in the manner of Embodiment 1, the first top edge 111, the second top edge 112, and the battery side 12B are isolated by the sealing surface in the area surrounded by the sealing frame 2. The coolant enters through an opening under the sealing frame 2 and contacts body 13 for cooling. But the cutting will not touch the coolant. The battery may be a hard-shell battery or a soft-pack battery.

Another battery module is shown in FIG. 9, which comprises three type B batteries 1B and a sealed frame 2B. The body 13 of battery 1B is immersed in the coolant to exchange heat with the coolant. The sealing frame 2B comprises two top edges and a side edge located on either side of the top edge. The top edge of the frame forms a sealing interface with the two top edges 111 and 112 of the battery 1B to seal the coolant to avoid coolant overflow. The side of the sealing frame forms a sealing interface with the side 12B of the battery 1B to seal and isolate the coolant to avoid coolant overflow or avoid direct contact between the cooling water and the cut edge of the battery. A fin is also arranged between the batteries, which is used to separate the batteries and form a coolant flow path between the batteries.

### Embodiment 3

This embodiment is roughly the same as Embodiment 1, except that the battery module in this embodiment has the following structure: the battery is optionally a soft-pack battery, the battery is wrapped by an aluminum-plastic film, the aluminum-plastic film contains an aluminum layer (8021 aluminum alloy), the battery has a hot sealing edge and a hot sealing side, the heat sealing side has a cut edge, and the cut edge has an aluminum layer; A second aluminum layer (or outer aluminum layer) is also wrapped in the aluminum-plastic film of the battery, and the aluminum layer in the cut edge is electrically insulated and anti-creepage treatment is performed between the aluminum layer and the second aluminum layer. The second aluminum layer is in direct contact with the coolant.

The aluminum-plastic film is a three-layer structure formed by PA layer, 8021 aluminum alloy layer and PP layer.

In order to make the electrical insulation strength (or voltage resistance strength) between the aluminum layer and the second aluminum layer in the cut edge of the aluminum-plastic film greater than 1800 volts, the cut edge on the heat sealing side of the battery is sealed by PI insulation film to avoid electrical communication or creepage between the 8021 aluminum layer in the cut edge and the second aluminum layer, or by the heat sealing side edge to avoid electrical communication or creepage between the 8021 aluminum alloy and the second aluminum layer.

The second aluminum layer extends to the outside of the battery side, and the two layers of the second aluminum layer on the outside of the battery side are bonded to each other to form a seal.

The inner side of the second aluminum layer wrapped in the battery is pre-backed with glue to make the second aluminum layer and the aluminum-plastic film fit well.

### Embodiment 4

FIG. 10 is a schematic diagram of another cell submodule of the invention, and the battery can be a square hard-shell battery or a soft-pack battery; Among them, the left picture of FIG. 10 shows two batteries 1B sandwiched with a piece of elastic foam 15, and the second aluminum foil layer is not shown in the left picture. FIG. 10 The right picture shows the section of the cell submodule in the direction of thickness, which has two cells 1B, a piece of elastic foam 15, and a second aluminum foil layer 16 wrapped around the outside of the battery 1B.

### Embodiment 5

FIG. 12 shows the hard-shell battery module, in which three hard-shell batteries 1C and two sealing frames 2C sandwiched among them are stacked. The top edge 11C of the hard-shell battery 1C is stacked with the top edge 21C of the adjacent sealing frame 2C, and the top edge 21C of the frame is in sealed contact with the top edge 11C of the battery. The top edge 11C of the battery is the edge on the side near the positive and negative tabs, which is used to set the seal. The hard-shell battery has 6 faces, which are top face, bottom face, 2 large side surface 10C and 2 small side surface. Its top edge 11C is on the large side surface 10C of the hard shell battery 1C.

The sealing frame 2C also comprises two frame side edges 22C, and the battery 1C also comprises two side edges 12C, and the side edge 12C of the battery is stacked between the side 12C of the battery and the side edge 22C of the adjacent sealing frame 2C, and the side edge 22C of the frame and the side 12C of the battery form a sealing interface. Its side 12C is the edge located on both sides of the said top edge 11C for setting the seal. The side 12C is on the edge of the large side surface 10C of the hard shell battery. Further, there is a lower cover plate on the bottom surface of the battery module for collecting coolant. The coolant flows only on the two sides of the battery 1C large surface 10C and the bottom surface, and the small side surface and top surface of the battery 1C do not contact the coolant.

### Embodiment 6

FIG. 4 shows a stack of six hard-shell cells 200 stacked along the thickness direction (stacked along the large side surface 202). The small side surfaces 201 and bottom surface 203 on both sides of the laminate are wrapped with a second packing layer 205 to form the battery group. The top edge of the sealing frame 206 is arranged on the top edge of the second packaging layer 205 near the pole lug 204, and the side edge of the sealing frame 207 is arranged on both sides of the top edge of the frame on the second packaging layer. The top edge of the frame 206 and the side edge of the frame 207 constitute a sealing frame. The sealing frame is formed by a sealant. The battery group comprising 6 cells in the present embodiment can be regarded as a whole or as a single battery, and then a plurality of battery groups and a plurality of sealing frames are stacked successively, with side plates sealed with the sealing frame on both sides, and a sealing bottom plate is arranged at the bottom to form the battery module.

### Embodiment 7

The battery stack shown in FIG. 5 consists of 6 cells 200, which consists of 2 layers of cells stacked along the thickness direction of the battery (large side stack) and 3 layers of cells stacked along the width direction of the battery (small side stack), and the second packaging layer (not shown in the figure) is covered on the large side surface and bottom of the two sides of the stack to form a battery group. The sealing top edge is arranged on the top edge near the pole lug on the second packaging layer, and the sealing side edge is arranged on both sides of the sealing top edge on the second packaging layer. The battery group in this embodiment can be regarded as a whole or as a single cell, and then a battery module consisting of a plurality of battery groups and a plurality of sealed frames can be applied to a battery module similar to that in embodiment 5. Among them, the 6 batteries are inverted, with the pole lug facing down and the bottom side facing up.

The above embodiments are illustrative in nature and in no way are intended to limit the scope or use of the invention.

1. A battery energy storage device, comprising:
a plurality of battery cells, wherein the battery cell is sheet-like, the two sides of the battery cell along the thickness direction of the main heat dissipation surface of the battery cell;
a box body comprising a bottom plate and a plurality of cooling plates arranged on the bottom plate;
a holding space formed between two adjacent cooling plates to accommodate the battery cell;
wherein the battery cell is installed in the accommodating space, and the main cooling surface on both sides of the battery cell is respectively fitted with two adjacent cooling plates.

2. The battery energy storage device according to claim 1, wherein the plurality of battery cells are arranged between two adjacent cooling plates; the battery cells are arranged successively along the length direction of the cooling plate;
wherein a positive electrode and a negative electrode are respectively arranged at both ends of the battery cell along the length direction of the cooling plate, and the positions of the positive electrode and the negative electrode of the adjacent two battery cells are relative;
wherein the positive and negative electrodes of the adjacent two cells are connected through the first connecting plate.

3. The battery energy storage device according to claim 2, wherein the cooling plate is provided with a plurality of central isolating components at intervals along the length direction;
wherein two adjacent battery cells are separated by the middle isolating component;
the first connection piece is arranged through the middle isolation member.
